(19) United States
(12) Patent Application Publication
(10) Pub. No.: US 2014/0064118 A1
(43) Pub. Date: Mar. 6, 2014

(54) APPARATUS AND METHOD FOR CONTROLLING SATELLITE TERMINAL

(71) Applicant: ELECTRONICS AND TELECOMMUNICATIONS RESEARCH INSTITUTE, (US)

(72) Inventors: Hyun Ha HONG, Seoul (KR); Man Kyu PARK, Daejeon (KR); Min Su SHIN, Daejeon (KR); Deock Gil OH, Daejeon (KR)

(73) Assignee: ELECTRONICS AND TELECOMMUNICATIONS RESEARCH INSTITUTE, Daejeon (KR)

(21) Appl. No.: 13/872,283

(22) Filed: Apr. 29, 2013

(30) Foreign Application Priority Data
Aug. 30, 2012 (KR) 10-2012-0095295

(51) Int. Cl. H04W 24/00

(52) U.S. Cl. CPC H04W 24/00
USPC 370/252

(57) ABSTRACT

Provided is a satellite terminal controlling apparatus and method that may measure a packet loss rate of a return link at a central station, may determine a modulation and coding (MODCOD) value of the return link using the packet loss rate, and may control MODCOD of a satellite terminal with respect to the return link.

### CROSS-REFERENCE TO RELATED APPLICATION

This application claims the priority benefit of Korean Patent Application No. 10-2012-0095295, filed on Aug. 30, 2012, in the Korean Intellectual Property Office, the disclosure of which is incorporated herein by reference.

### BACKGROUND

1. Field of the Invention

Embodiments of the present invention relate to a satellite terminal controlling apparatus that may compensate for rainfall attenuation based on satellite return link encapsulation (RLE).

2. Description of the Related Art

Currently, an Internet service based on a satellite network has been generalized. Accordingly, there is a rising need for technology that enables a satellite terminal to maintain the predetermined quality of service even in a rainfall attenuation environment.

A method of maintaining the quality of satellite service in a rainfall environment may include a method of maintaining the quality of service even in the rainfall environment by measuring and predicting a signal-to-noise ratio (SNR) with respect to a digital video broadcasting over satellite 2 (DVB-S2) forward link and by controlling power and adaptive coding and modulation (ACM) with respect to a satellite link.

The above method may adapt to a change in the rainfall using the SNR. When fast fading occurs or when a change rate of rainfall attenuation is great, system availability may decrease and the quality of service may be degraded due to erroneous modulation and coding (MODCOD) application.

Satellite ACM technology may cope with signal attenuation occurring due to rainfall by changing a MODCOD value using return link encapsulation (RLE)-based packet error detection. However, the above method considers only a packet loss rate of a current point in time and thus, may have constraints on quickly adapting a MODCOD value to a channel change when an attenuation change rate is great.

### SUMMARY

According to an aspect of the present invention, there is provided an apparatus for controlling a satellite terminal, the apparatus including: a packet loss rate measuring unit to measure a packet loss rate of a central station; a modulation and coding (MODCOD) determining unit to determine an MODCOD value of the central station using the packet loss rate; and a MODCOD controlling unit to control MODCOD of the satellite terminal with respect to a return link.

The central station and the satellite terminal may have a return link encapsulation (RLE) based return link access function.

The packet loss rate measuring unit may perform an accumulative operation with respect to the number of packet losses by consecutively reassembling a packet received.

The packet loss rate measuring unit may include a packet loss rate predicting unit to predict a packet loss rate of a future point in time based on a gradient of a change in a packet loss rate, when a packet loss rate of a current point in time is greater than a packet loss rate of a just-previous point in time.

When a packet loss rate of a current point in time is greater than a packet loss rate of a just-previous point in time, the MODCOD determining unit may determine the MODCOD value of the central station to have a low modulation rate and a low coding rate based on a packet loss rate of a future point in time.

When a packet loss rate of a current point in time is less than a packet loss rate of a just-previous point in time, the MODCOD determining unit may determine the MODCOD value of the central station to have a high modulation rate and a low coding rate based on a packet loss rate of a future point in time.

The MODCOD determining unit may transmit the determined MODCOD value from the central station to the satellite terminal.

The MODCOD controlling unit may control the satellite terminal to update a modulation rate and a coding rate of the return link per a frame unit based on the received MODCOD value and thereby transmit data.

When a packet loss rate of a current point in time is identical to a packet loss rate of a just-previous point in time, the MODCOD determining unit may determine the MODCOD value of the central station to maintain an MODCOD value of the current point time.

The MODCOD controlling unit may control the satellite terminal to transmit data without changing the MODCOD value.

According to another aspect of the present invention, there is provided a method of controlling a satellite terminal, the method including: measure a packet loss rate of a return link at a central station; determining an MODCOD value of the return link using the packet loss rate; and controlling MODCOD of the satellite terminal with respect to the return link.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a satellite terminal controlling apparatus according to an embodiment of the present invention;

FIG. 2 is a diagram illustrating an example of playing an Internet protocol (IP) packet using a return link between a satellite terminal and a central station;

FIG. 3 is a diagram illustrating an example of a type and a structure of a packet used by a return link encapsulation (RLE) access scheme with respect to a return link between a satellite terminal and a central station;

FIG. 4 is a diagram illustrating an example of detecting an error with respect to reassembly of an RLE packet when a transmission error is absent;

FIG. 5 is a diagram illustrating an example of detecting an error with respect to reassembly of an RLE packet when a loss with respect to a single packet occurs;

FIG. 6 is a diagram illustrating an example of detecting an error with respect to reassembly of an RLE packet when a loss with respect to a start packet occurs;

FIG. 7 is a diagram illustrating an example of detecting an error with respect to reassembly of an RLE packet when a loss with respect to two packets occurs;

FIG. 8 is a diagram illustrating another example of detecting an error with respect to reassembly of an RLE packet when a loss with respect to two packets occurs;

FIG. 9 is a flowchart illustrating a satellite terminal controlling method according to an embodiment of the present invention;

FIG. 10 is a flowchart illustrating a method of performing an error detection with respect to packet reassembly and an accumulative detection with respect to a total packet loss amount; and

FIG. 11 is a flowchart illustrating a satellite terminal controlling method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

A satellite terminal controlling apparatus according to an embodiment of the present invention may maintain system availability even in the case of satellite rainfall, and may provide the high quality of service to a subscriber by applying adaptive coding and modulation (ACM) controlling technology to a satellite terminal using a method of measuring and predicting a packet loss based on return link encapsulation (RLE).

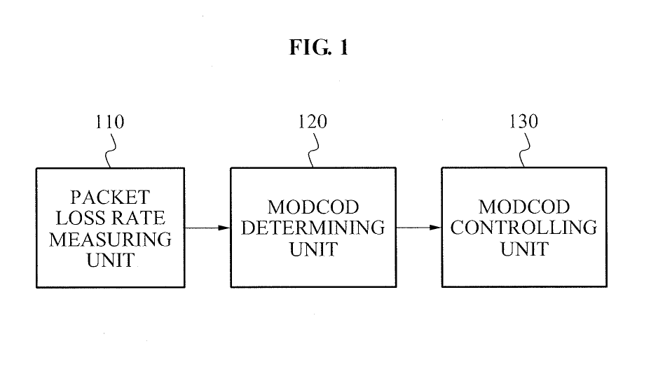

FIG. 1 is a block diagram illustrating a configuration of a satellite terminal controlling apparatus according to an embodiment of the present invention.

Referring to FIG. 1, the satellite terminal communication apparatus may include a packet loss rate measuring unit 110 to measure a packet loss rate of a central station, a modulation and coding (MODCOD) determining unit 120 to determine an MODCOD value of the central station using the packet loss rate, and a MODCOD controlling unit 130 to control MODCOD of a satellite terminal with respect to a return link. Here, the central station and the satellite terminal may have an RLE based return link access function.

The packet loss rate measuring unit 110 may perform an accumulative operation with respect to the number of packet losses by consecutively reassembling a packet received.

When a packet loss rate of a current point in time (hereinafter, a current packet loss rate) is greater than a packet loss rate of a just-previous point in time (hereinafter, a previous packet loss rate), the packet loss rate measuring unit 110 may predict a packet loss rate of a future point in time (hereinafter, a future packet loss rate) based on a gradient of a change in a packet loss rate, using a packet loss rate predicting unit (not shown).

When the current packet loss rate is greater than the previous packet loss rate, the MODCOD determining unit 120 may determine the MODCOD value of the central station to have a low modulation rate and a low coding rate based on the future packet loss rate.

When the current packet loss rate is less than the previous packet loss rate, the MODCOD determining unit 120 may determine the MODCOD value of the central station to have a high modulation rate and a low coding rate based on the future packet loss rate.

Here, the MODCOD determining unit 120 may transmit the determined MODCOD value from the central station to the satellite terminal. The MODCOD controlling unit 130 may control the satellite terminal to update a modulation rate and a coding rate of the return link per a frame unit based on the received MODCOD value and thereby transmit data.

When the current packet loss rate time is identical to the previous packet loss rate, the MODCOD determining unit 120 may determine the MODCOD value of the central station to maintain an MODCOD value of the current point time. The MODCOD controlling unit 130 may control the satellite terminal to transmit data without changing the MODCOD value.

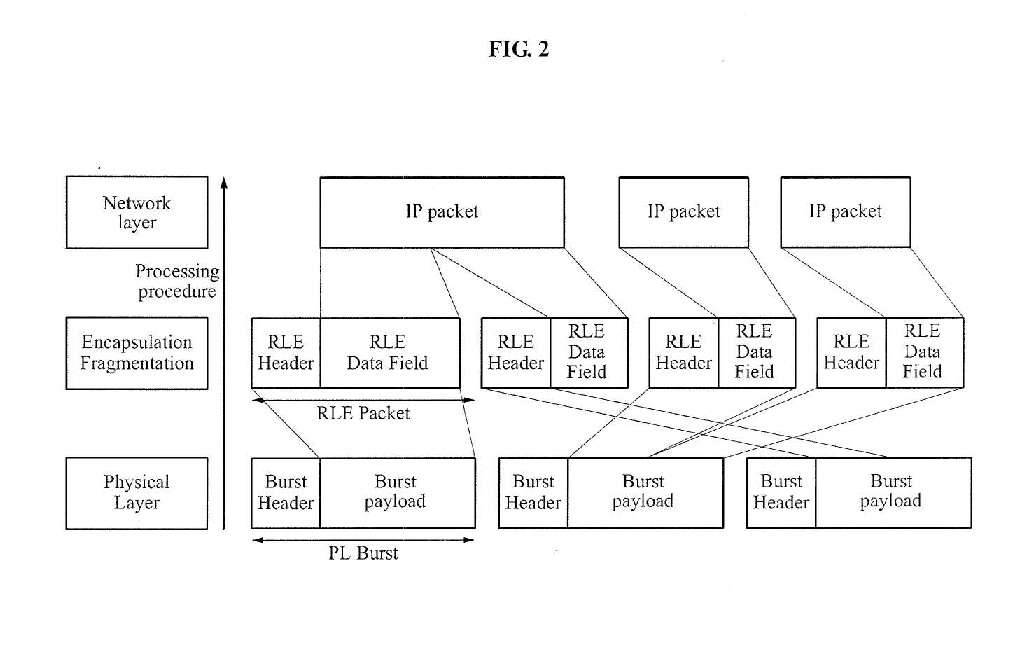

FIG. 2 is a diagram illustrating an example of playing an Internet protocol (IP) packet using a return link between a satellite terminal and a central station.

Referring to FIG. 2, a satellite terminal controlling apparatus according to an embodiment of the present invention may play an IP packet using a network hierarchy by enabling the IP packet to pass through a physical layer and an RLE reception layer from a traffic burst of the satellite terminal.

An IP datagram may be fragmented into a plurality of RLE packets based on a length of a traffic burst payload of the physical layer that is determined during a resource allocation process and thereby be transferred. The physical layer may perform a cyclic redundancy check (CRC) with respect to a received burst and may transfer burst payload data to an upper layer.

A defragmentation/decapsulation layer (not shown) may reassemble fragmented RLE packet payload data into the IP packet by analyzing an RLE packet header with respect to a burst payload, and may perform an error check with respect to reassembly of an RLE packet. When an error is absent, the defragmentation/decapsulation layer may transfer the reassembled IP packet to a network layer that is an upper layer.

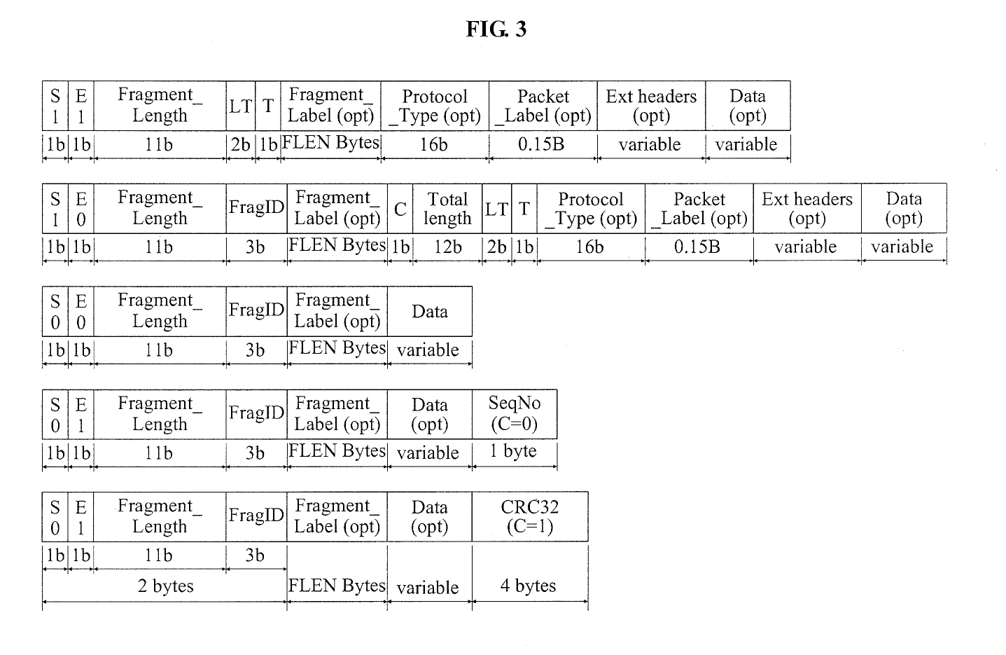

FIG. 3 is a diagram illustrating an example of a type and a structure of a packet used by an RLE access scheme with respect to a return link between a satellite terminal and a central station.

Referring to FIG. 3, an RLE packet header may have a fixed length of two bits. Four types of RLE packets may be configured based on an S/E field value. For example, the above four types of RLE packets may include a full packet of which packet fragmentation is not performed and of which S/E field value is “1/1” and three types of RLE packets of which packet fragmentation is performed. Here, three types of RLE packets of which packet fragmentation is performed may include a start packet of which S/E field value is “1/0”, an intermediate packet of which S/E field value is “0/0”, and an end packet of which S/E field value is “0/1”.

According to an aspect of the present invention, the end packet may be provided in a sequence number (SeqNo) and CRC32 packet form, and may perform a corresponding reassembly error detection algorithm based on a C field value that is present in a header of the start packet.

Hereinafter, a method of detection an error with respect to packet assembly in a return link between a satellite terminal and a central station according to an embodiment of the present invention will be described.

In an RLE access scheme having the end packet using a sequence number (SeqNo) scheme, the satellite terminal controlling apparatus may detect an error with respect to the packet assembly that may occur based on the rainfall attenuation.

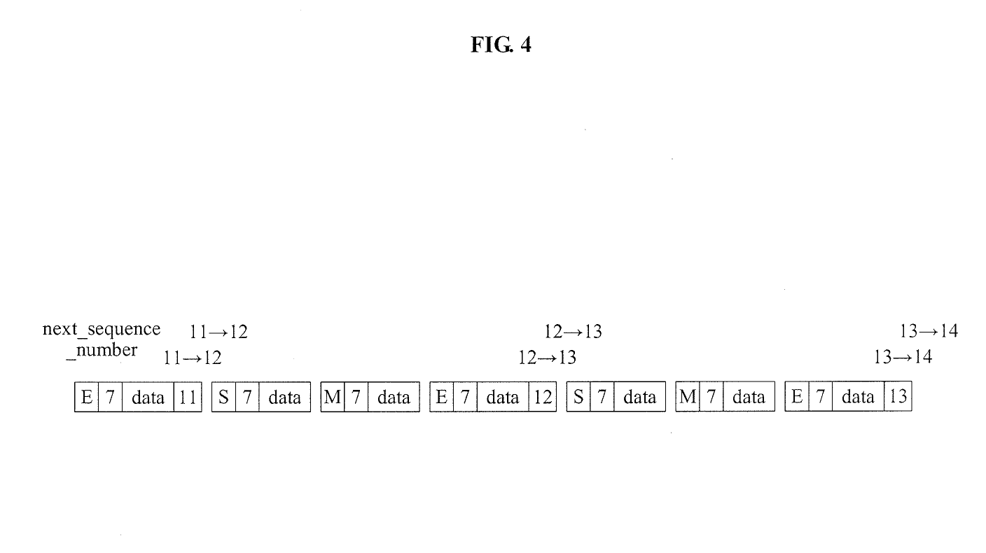

FIG. 4 is a diagram illustrating an example of detecting an error with respect to reassembly of an RLE packet when a transmission error is absent.

Referring to FIG. 4, a changed number in a lower end of a next sequence number (next_sequence_number) denotes a changed value of next_sequence_number when a transmission end performs packet fragmentation. The satellite terminal controlling apparatus may determine a SeqNo field value of an end packet based on the changed value.

A changed number in an upper end of next_sequence_number denotes a changed value of next_sequence_number when a reception end performs packet reassembly. When an end packet having the same SeqNo field value as next_sequence_number is received, the satellite terminal controlling apparatus may determine that the packet reassembly is normal and thereby process the packet reassembly. In the above case, the number of detected packet errors may be “zero”.

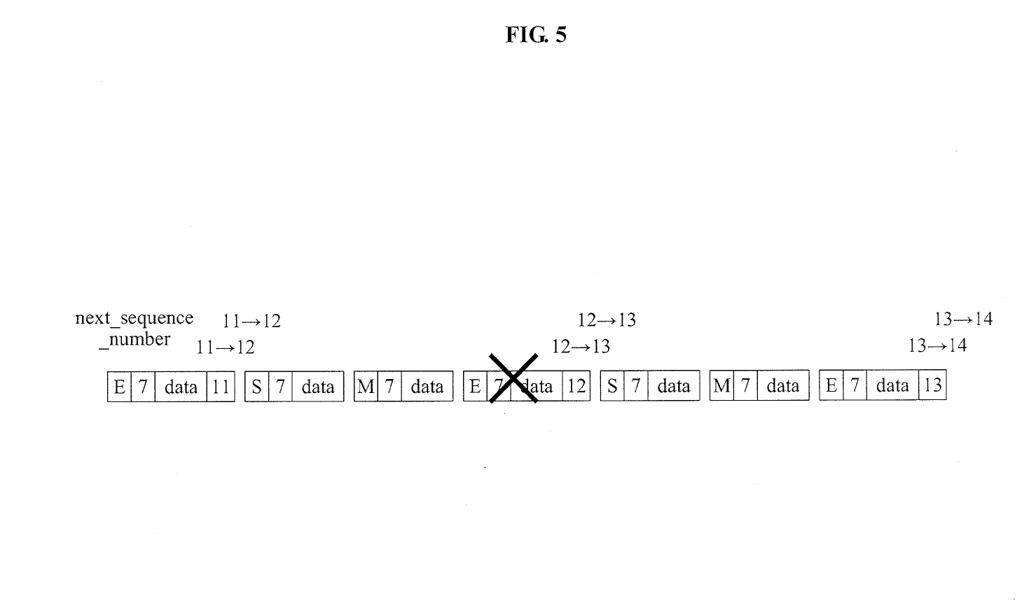

FIG. 5 is a diagram illustrating an example of detecting an error with respect to reassembly of an RLE packet when a loss with respect to a single packet occurs.

When an end packet having a SeqNo field value of “12” is lost, the satellite terminal controlling apparatus may update a value of next_sequence_number by a next start packet. In a state in which next_sequence_number is “13”, the satellite terminal controlling apparatus may normally receive and process an intermediate packet and an end packet having the SeqNo field value of “13”. In the above case, the number of detected packet errors may be “1”.

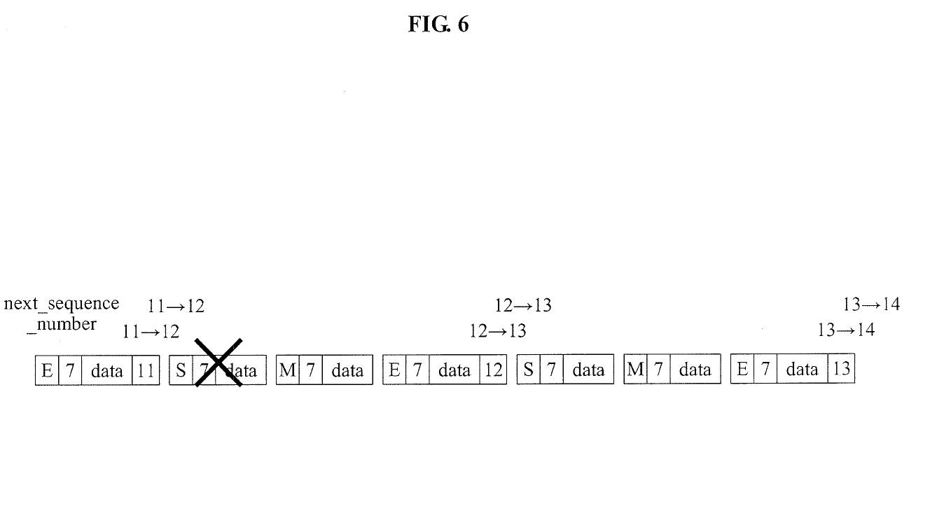

FIG. 6 is a diagram illustrating an example of detecting an error with respect to reassembly of an RLE packet when a loss with respect to a start packet occurs.

Referring to FIG. 6, the satellite terminal controlling apparatus may update a value of next_sequence_number by an end packet having a SeqNo field value of “12”. In a state in which next_sequence_number is “13”, the satellite terminal controlling apparatus may normally receive and process an intermediate packet and an end packet having the SeqNo field value of “13”. In the above case, the number of detected packet errors may be “1”.

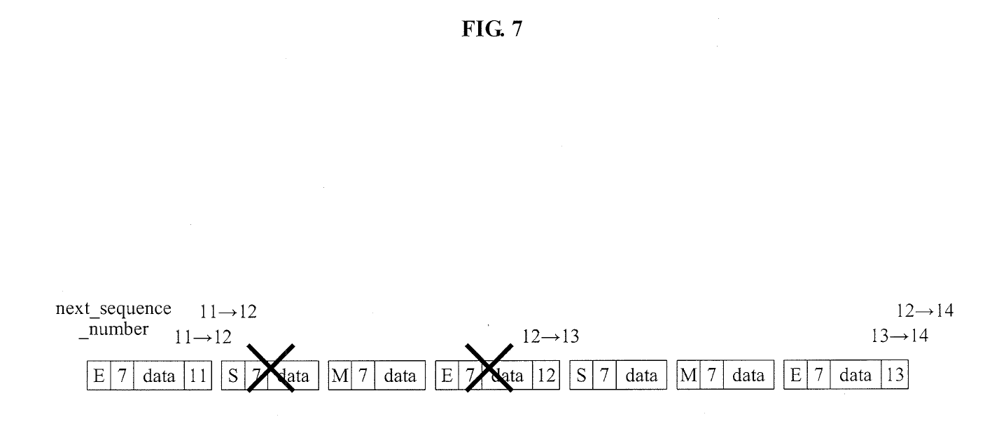

FIG. 7 is a diagram illustrating an example of detecting an error with respect to reassembly of an RLE packet when a loss with respect to two packets occurs.

Referring to FIG. 7, the satellite terminal controlling apparatus may lose a preceding start packet and an end packet having a SeqNo field value of “12”. Here, a value of next_sequence_number may not be updated. Accordingly, in a state in which next_sequence_number is “12”, even though an end packet having a SeqNo field value of “13”, the preceding start packet, and an intermediate packet are normally received, the satellite terminal controlling apparatus may determine that an error has occurred with respect to reassembly of an RLE packet due to mismatch between SeqNo field values and thus may perform deletion processing. In the above case, the number of detected packet errors may be “2”.

For example, when a plurality of pairs of end packets and start packets are consecutively lost, the satellite terminal controlling apparatus may calculate a total number of detected packet errors according to Equation 1:

Total number of detected packet errors=SeqNo field value of reassembled end packet−value of next_sequence_number+1 [Equation 1]

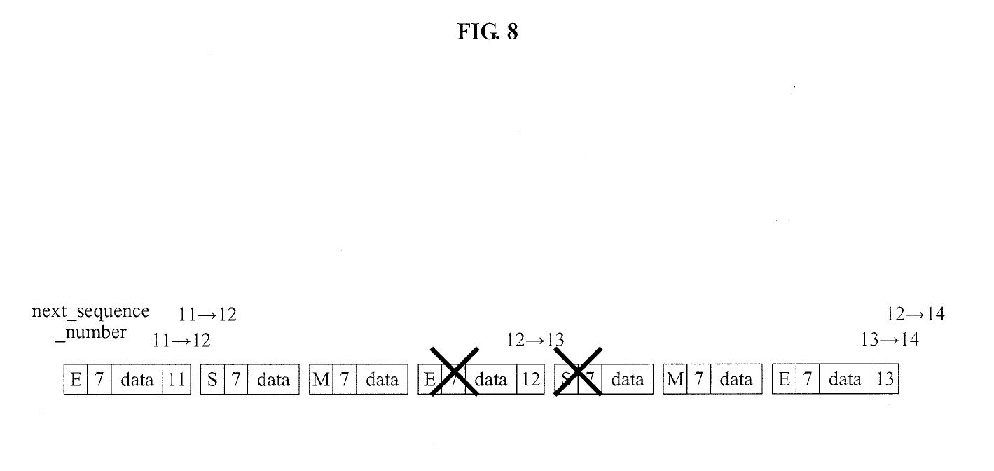

FIG. 8 is a diagram illustrating another example of detecting an error with respect to reassembly of an RLE packet when a loss with respect to two packets occurs.

Referring to FIG. 8, when a pair of an end packet having a SeqNo field value of “12” and a following start packet are lost, a total length (Total_Length) may be the same as a length of a reassembled packet regardless of the above packet lost.

Since the end packet having the SeqNo field value of “12” and the following start packet are consecutively lost, a value of next_sequence_number may not be updated. Accordingly, in a state in which next_sequence_number is “12”, an end packet having a SeqNo field value of “13” is received. Accordingly, the satellite terminal controlling apparatus may determine that an error has occurred in the reassembled packet and may perform deletion processing. In the above case, the number of detected packet errors may be “2”.

For example, when a plurality of pairs of end packets and following start packets are consecutively lost, the satellite controlling apparatus may calculate a total number of detected packet errors according to Equation 2:

Total number of detected packet errors=SeqNo field value of assembled end packet−value of next_sequence_number+1 [Equation 2]

According to an embodiment of the present invention, the satellite terminal controlling apparatus may simply calculate a sudden packet loss change rate occurring due to a plurality of burst losses by employing a SeqNo based RLE scheme.

Hereinafter, a satellite terminal controlling method according to an embodiment of the present invention will be described.

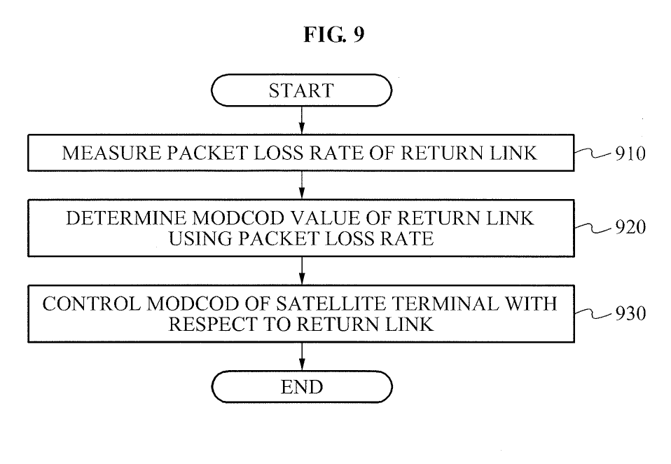

FIG. 9 is a flowchart illustrating a satellite terminal controlling method according to an embodiment of the present invention.

Referring to FIG. 9, a satellite terminal controlling apparatus may control a central station to measure a packet loss rate of a return link in operation 910.

In operation 920, the satellite terminal controlling apparatus may determine a MODCOD value of the return link using the packet loss rate.

In operation 930, the satellite terminal controlling apparatus may control MODCOD of a satellite terminal with respect to the return link.

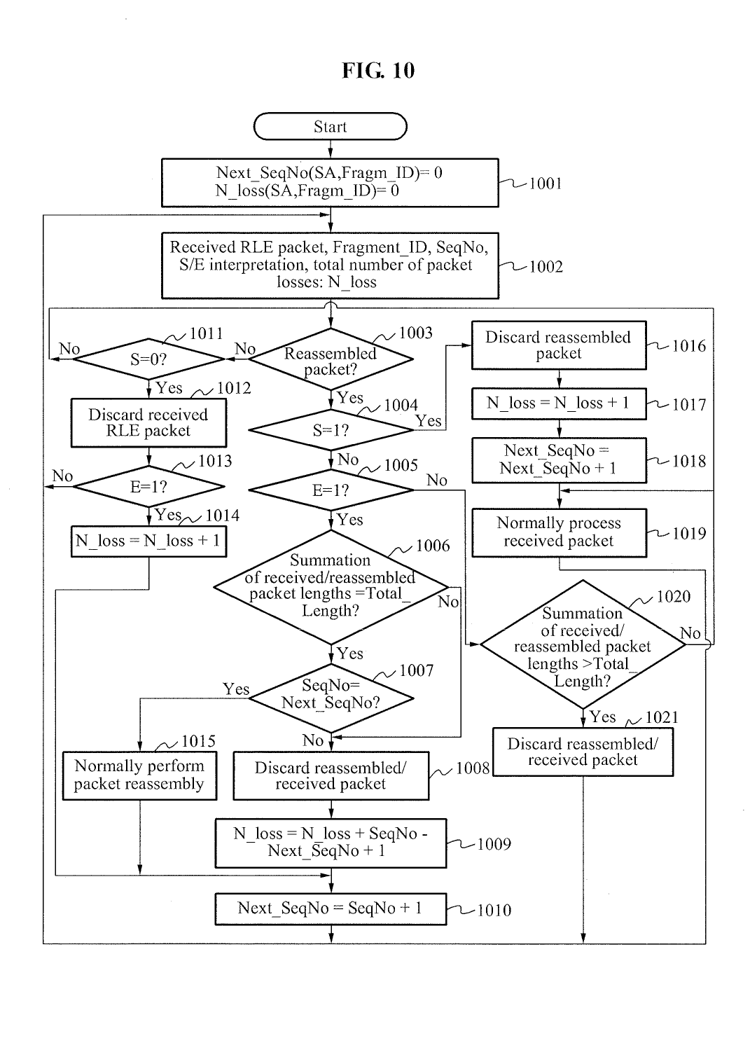

FIG. 10 is a flowchart illustrating a method of performing an error detection with respect to packet reassembly and an accumulative detection with respect to a total packet loss amount.

Referring to FIG. 10, the satellite terminal controlling apparatus may detect a reassembly error by applying rules for a variety of reassembly error detection, and may detect a reassembly error as in the following algorithm by employing, as variables, an S/E value, presence of a reassembled packet, SeqNo matching, Total_Length matching, and the like.

The satellite terminal controlling apparatus may initialize a next sequence number (Next_SeqNo) and an initial loss rate (N_loss) in operation 1001, and may identify a received RLE packet SA, a fragment identifier (Fragment_ID), SeqNo, S/E interpretation, and a total number of packet losses in operation 1002.

The satellite terminal controlling apparatus may determine whether a reassembled packet is present in operation 1003, and may determine whether an S field value (S) is “1” in operation 1004, and whether an E field value (E) is “1” in operation 1005.

When S≠1, and when E=1, the satellite terminal controlling apparatus may determine whether summation of received/reassembled packet lengths=Total_Length in operation 1006. When the summation=Total_Length, the satellite terminal controlling apparatus may determine whether SeqNo=Next_SeqNo in operation 1007. When SeqNo=Next_SeqNo, the satellite terminal controlling apparatus may normally perform packet reassembly in operation 1015.

On the contrary, when SeqNo≠Next_SeqNo, the satellite terminal controlling apparatus may discard reassembled/received packet in operation 1008, may calculate a total number of detected packet errors according to Equation 1 in operation 1009, and may increase Next_SeqNo by “1” in operation 1010.

When S=1, the satellite terminal controlling apparatus may discard the reassembled packet in operation 1016, may increase the number of packet errors by “1” in operation 1017, may increase Next_SeqNo by “1” in operation 1018, and may normally process the received packet in operation 1019.

When S≠1 and when E≠1, the satellite terminal controlling apparatus may determine whether summation of received/reassembled packet lengths=Total_Length in operation 1020. When the summation≠Total_Length, the satellite terminal controlling apparatus may discard the reassembled/received packet in operation 1021.

When the reassembled packet is absent, the satellite terminal controlling apparatus may determine whether S=0 in operation 1011. When S=0, the satellite terminal controlling apparatus may discard a received RLE packet in operation 1012. Also, the satellite terminal controlling apparatus may determine whether E=1 in operation 1013. When E=1, the satellite terminal controlling apparatus may increase the number of packet errors by “1” in operation 1014.

According to an embodiment of the present invention, a total packet loss amount may have a different procedure with respect to each of a case in which a single packet loss occurs for each satellite terminal and a case in which a plurality of packet losses occurs for each satellite terminal. A temporal change rate with respect to a packet loss may be accumulatively calculated by normalizing the total number of packet losses at predetermined time intervals.

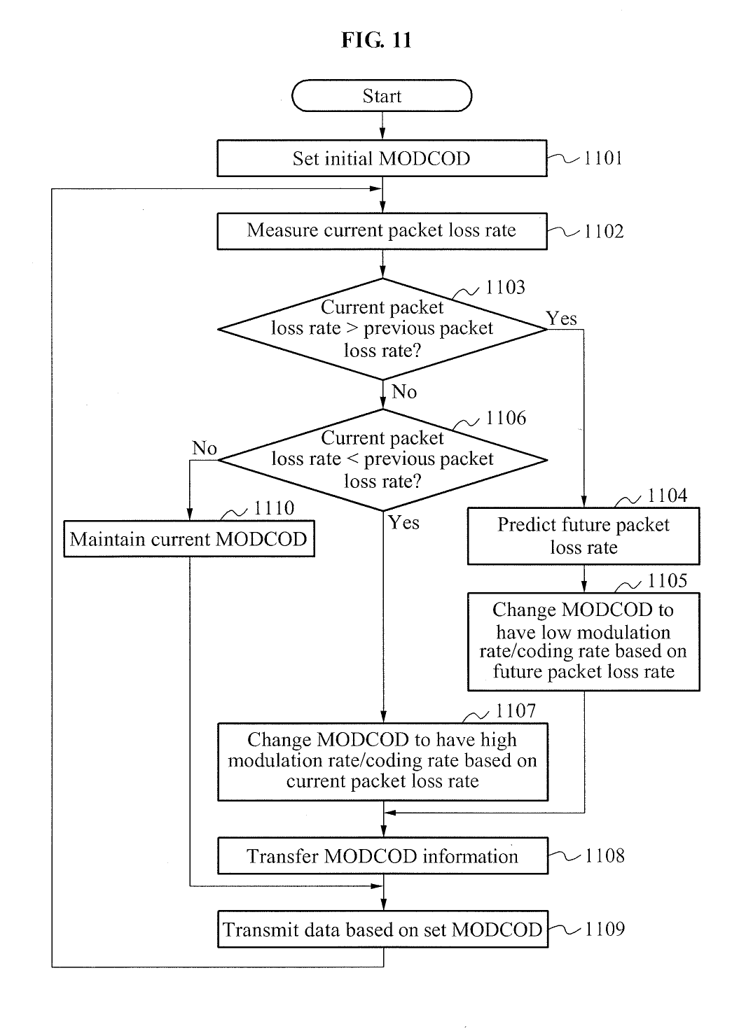

FIG. 11 is a flowchart illustrating a satellite terminal controlling method according to another embodiment of the present invention.

Referring to FIG. 11, in a SeqNo-based RLE access scheme with respect to a return link between a satellite terminal and a central station, the satellite terminal controlling apparatus may maintain system availability and a predetermined level of quality even in the case of the rainfall attenuation by measuring and predicting a change in a packet loss rate at each of a past point in time, a current point in time, and a future point in time.

The satellite terminal controlling apparatus may set an initial MODCOD value in operation 1101, and may measure a current packet loss rate in operation 1102.

The satellite terminal controlling apparatus may compare the current packet loss rate of the current point in time with a previous packet loss rate in operations 1103 and 1106. When the current packet loss rate is greater than the previous packet loss rate, the satellite terminal controlling apparatus may predict a future packet loss rate in operation 1104 and may change the MODCOD value to have a robust low modulation rate and a low coding rate based on the future packet loss rate in operation 1105.

On the contrary, when the current packet loss rate is less than the previous packet loss rate, the satellite terminal controlling apparatus may change the MODCOD value to have a high modulation rate and a high coding rate based on the current packet loss rate in operation 1107.

After changing each MODCOD value, the satellite terminal controlling apparatus may transfer MODCOD information to the satellite terminal in operation 1108, and may transmit data based on set MODCOD in operation 1109.

When the current packet loss rate is identical to the previous packet loss rate, the satellite terminal controlling apparatus may maintain a MODCOD value of the current point in time in operation 1110.

Since a single packet loss or a plurality of packet losses occurs, the satellite terminal controlling apparatus may accumulatively calculate a packet loss rate at predetermined time intervals. When a current packet loss rate suddenly increases, the satellite terminal controlling apparatus may predict a future packet loss rate and may change a MODCOD value to have a low modulation rate and a low coding rate, which are robust against the rainfall, based on the predicted future packet loss rate and thereby transfer the changed MODCOD value to a satellite terminal, thereby preventing quality degradation that may occur due to the rainfall attenuation.

When the current packet loss rate decreases compared to a previous packet loss rate, signal attenuation may decrease. Accordingly, the satellite terminal controlling apparatus may change the MODCOD value to have a high modulation rate and a high coding rate based on the current packet loss rate, and may inform the satellite terminal about the changed MODCOD value, thereby preventing a received signal error that may occur due to erroneous prediction about a channel environment of a future point in time.

In a stable channel state in which the current packet loss rate and the previous packet loss rate have not greatly changed, the satellite terminal controlling apparatus may continue data communication by maintaining current MODCOD.

According to an aspect, even in a case in which a received satellite signal suddenly changes due to rainfall attenuation, the satellite terminal controlling apparatus may maintain the quality of service to be a predetermined level.

According to an aspect, with respect to an ACM operation of a satellite terminal, it is possible to measure and predict a packet loss rate based on satellite RLE.

According to an aspect, in a satellite rainfall attenuation environment, it is possible to maintain the quality of satellite Internet service for a subscriber, and to improve system availability.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for controlling a satellite terminal, the apparatus comprising:
a packet loss rate measuring unit to measure a packet loss rate of a central station;
a modulation and coding (MODCOD) determining unit to determine an MODCOD value of the central station using the packet loss rate; and
a MODCOD controlling unit to control MODCOD of the satellite terminal with respect to a return link.

2. The apparatus of claim 1, wherein the central station and the satellite terminal have a return link encapsulation (RLE) based return link access function.

3. The apparatus of claim 1, wherein the packet loss rate measuring unit performs an accumulative operation with respect to the number of packet losses by consecutively reassembling a packet received.

4. The apparatus of claim 1, wherein the packet loss rate measuring unit comprises:
a packet loss rate predicting unit to predict a packet loss rate of a future point in time based on a gradient of a change in a packet loss rate, when a packet loss rate of a current point in time is greater than a packet loss rate of a just-previous point in time.

5. The apparatus of claim 1, wherein when a packet loss rate of a current point in time is greater than a packet loss rate of a just-previous point in time, the MODCOD determining unit determines the MODCOD value of the central station to have a low modulation rate and a low coding rate based on a packet loss rate of a future point in time.

6. The apparatus of claim 1, wherein when a packet loss rate of a current point in time is less than a packet loss rate of a just-previous point in time, the MODCOD determining unit determines the MODCOD value of the central station to have a high modulation rate and a low coding rate based on a packet loss rate of a future point in time.

7. The apparatus of claim 5, wherein the MODCOD determining unit transmits the determined MODCOD value from the central station to the satellite terminal.

8. The apparatus of claim 7, wherein the MODCOD controlling unit controls the satellite terminal to update a modulation rate and a coding rate of the return link per a frame unit based on the received MODCOD value and thereby transmit data.

9. The apparatus of claim 1, wherein when a packet loss rate of a current point in time is identical to a packet loss rate of a just-previous point in time, the MODCOD determining unit determines the MODCOD value of the central station to maintain an MODCOD value of the current point time.

10. The apparatus of claim 9, wherein the MODCOD controlling unit controls the satellite terminal to transmit data without changing the MODCOD value.

11. A method of controlling a satellite terminal, the method comprising:
measure a packet loss rate of a return link at a central station;
determining a modulation and coding (MODCOD) value of the return link using the packet loss rate; and
controlling MODCOD of the satellite terminal with respect to the return link.

12. The method of claim 11, wherein the central station and the satellite terminal have a return link encapsulation (RLE) based return link access function.

13. The method of claim 11, wherein the measuring comprises performing an accumulative operation with respect to the number of packet losses by consecutively reassembling a packet received.

14. The method of claim 11, wherein the measuring comprises:
predicting a packet loss rate of a future point in time based on a gradient of a change in a packet loss rate, when a packet loss rate of a current point in time is greater than a packet loss rate of a just-previous point in time.

15. The method of claim 11, wherein the determining comprises determining the MODCOD value to have a low modulation rate and a low coding rate based on a packet loss rate of a future point in time, when a packet loss rate of a current point in time is greater than a packet loss rate of a just-previous point in time.

16. The method of claim 11, wherein the determining comprises determining the MODCOD value to have a high modulation rate and a low coding rate based on a packet loss rate of a future point in time when a packet loss rate of a current point in time is less than a packet loss rate of a just-previous point in time.

17. The method of claim 15, wherein the determining comprises transmitting the determined MODCOD value from the central station to the satellite terminal.

18. The method of claim 17, wherein the controlling comprises controlling the satellite terminal to update a modulation rate and a coding rate of the return link per a frame unit based on the received MODCOD value and thereby transmit data.

19. The method of claim 11, wherein the determining comprises determining the MODCOD value of the central station to maintain an MODCOD value of the current point time when a packet loss rate of a current point in time is identical to a packet loss rate of a just-previous point in time.

20. The method of claim 19, wherein the controlling comprises controlling the satellite terminal to transmit data without changing the MODCOD value.
